(19) United States
(12) Patent Application Publication
(10) Pub. No.: US 2003/0122664 A1
(43) Pub. Date: Jul. 3, 2003

(54) Structure of a vehicle side mirror signal light

(76) Inventor: Chi-Lieh Liu, Tainan Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/029,138

(22) Filed: Dec. 31, 2001

(51) Int. Cl. B60Q 1/34

(52) U.S. Cl. 340/475

(57) ABSTRACT

A side mirror signal light of a vehicle comprises a mirror body secured to the vehicle, having a warning light, a front transparent piece and a rear transparent piece secured thereon. The warning light emits from both the front and the rear transparent pieces that can be easily visible to drivers from other vehicles.

### BACKGROUND OF THE INVENTION

### FIELD OF THE DISCLOSURE

This invention relates to a vehicle side mirror, and more particular to a mirror equipped with a warning light, which is easily be visible able by other drivers or pedestrians.

With new technology continuous developed, a vehicle is designed with a smooth and modem appearance to attract consumers. However, due to the modern design, some vehicle bodies blocks the sight of the signal lights and causes an accident.

In view of this and many others, the inventor has invented the present invention, which has a visible signal light and may prevent an accident caused by an unclear signal light.

### SUMMARY OF THE INVENTION

It is the primary object of the present invention to provide a structure of a vehicle side mirror signal light, which increases the visibility of the light, thus eliminates a dead angle.

It is another object of the present invention to provide a structure of a vehicle side mirror signal light, which is safer for a driver and other drivers.

It is a further object of the present invention to provide a structure of a vehicle side mirror signal light, which is economical in mass production.

### DETAILED DESCRIPTION OF THE DRAWINGS

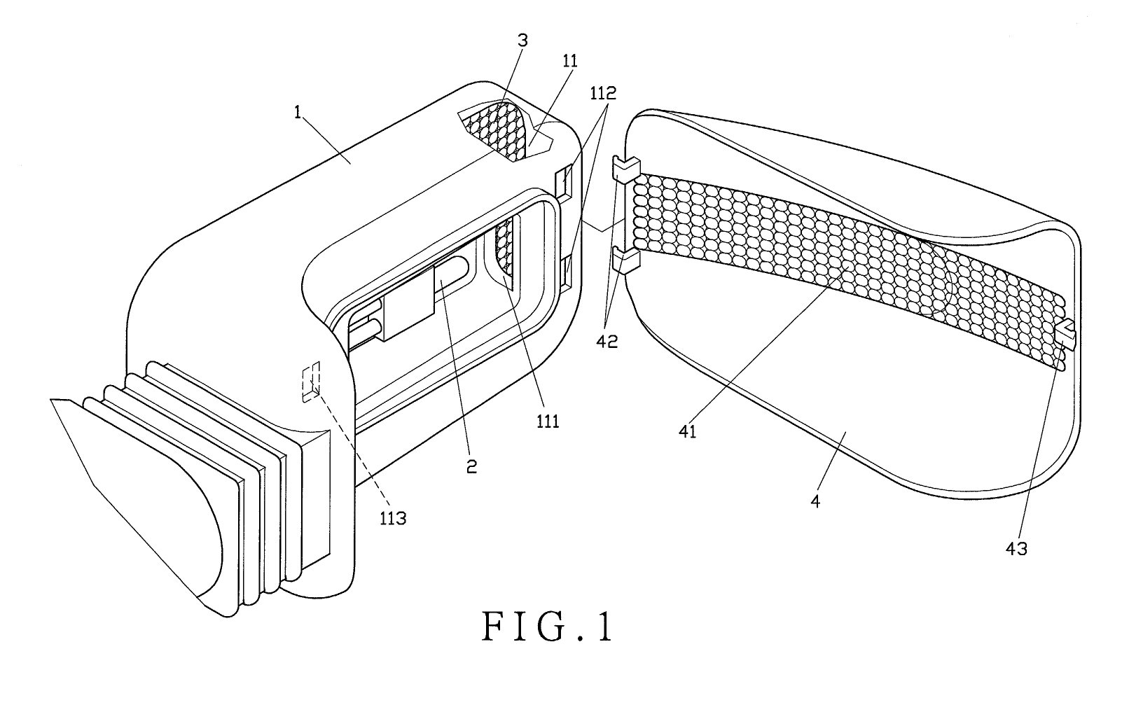

FIG. 1 is an exploded view of the present invention;

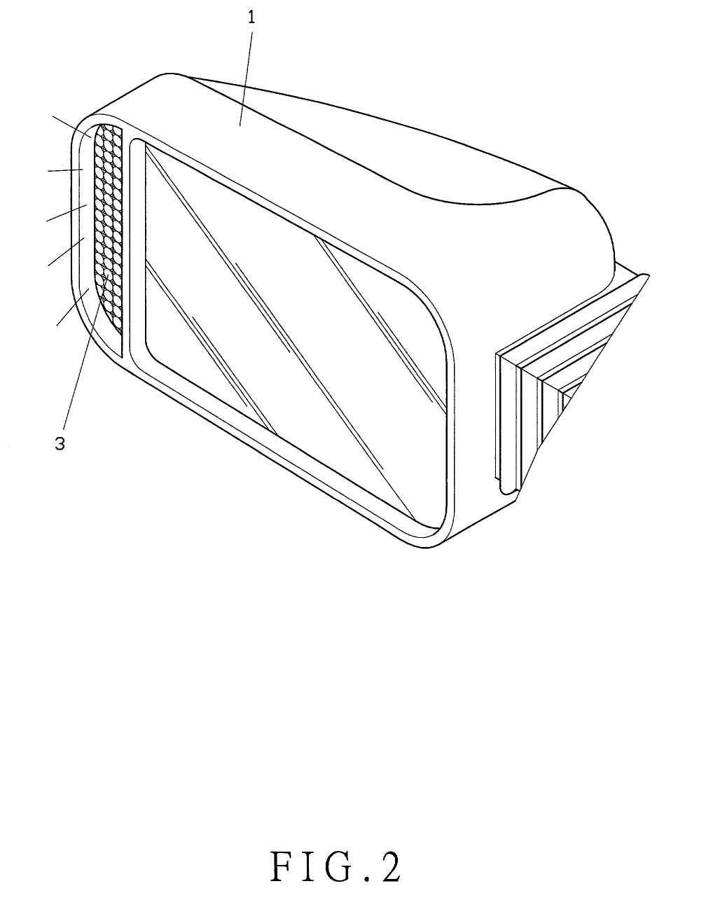

FIG. 2 is a front view of the present invention, and

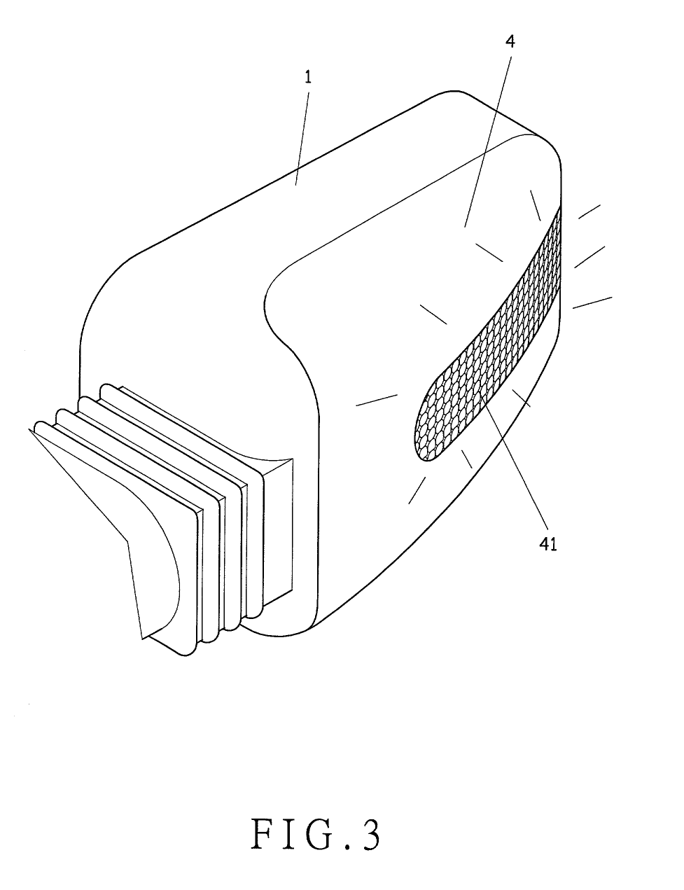

FIG. 3 is a rear view of the present invention.

### DETAILED DESCRIPTION OF THE PREFERRED EMBODIMENTS

The side mirror with a signal light comprises a mirror body 1 having a warning light 2, a front transparent piece 3, and a rear transparent piece 4 secured therein. The mirror body 1 secured to a vehicle has a chamber 11 at the front end to hold the front transparent piece 3 thereat. The chamber 11 has a hole 111 for the warning light 2 to extend there through and emits the light from the front transparent piece 3. The chamber 11 also comprises a pair of apertures 112 at the rear end. The mirror body 1 has an aperture 113 at the rear end. The rear transparent piece 4 is secured at the rear end of the mirror body 1 corresponding to the warning light 2, and has a transparent area 41, which is made of transparent material, and is formed with three clamps 42 and 43, which correspond to the apertures 112 and 113, respectively.

In practice, as shown in FIGS. 2 and 3, the warning light 2 emits from the front and the rear transparent pieces 3 and 4, which allows drivers from both the front direction and at the rear direction to detect and to take precaution in advance.

I claim:

1. A structure of a vehicle side mirror signal light comprising a mirror body having a warning light, a front transparent piece, and a rear transparent piece secured therein, wherein said mirror body being secured to said s vehicle, and comprising a chamber at the front end for said front transparent piece to be secured thereat, and said rear transparent piece to be secured at the rear end of said mirror body, whereas said warning light emitting from both said front transparent piece and said rear transparent piece allowing drivers from both the front and the rear directions to detect and to take precaution in advance.
